(19) United States
(12) Patent Application Publication
(10) Pub. No.: US 2007/0041578 A1
(43) Pub. Date: Feb. 22, 2007

(54) Electronic apparatus

(75) Inventor: Hajime Ohsawa, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/437,043

(22) Filed: May 19, 2006

(30) Foreign Application Priority Data
May 26, 2005 (JP) P2005-153974

(51) Int. Cl. H04M 1/00

(52) U.S. Cl. 379/433.1

(57) ABSTRACT

An electronic apparatus includes: an operation button that allows to input remote operation for remotely controlling another apparatus; and a switching unit that switches a function of the remote operation allocated to the operation button in accordance with a change of a state of the another apparatus.

### CROSS-REFERENCE TO RELATED APPLICATIONS

This application is based upon and claims the benefit of priority from Japanese Patent Application No. 2005-153974, filed on May 26, 2005, the entire contents of which are incorporated herein by reference.

### BACKGROUND

1. Field

One embodiment relates to a remote controlling technique preferably applied to a cellular phone having a function of remotely controlling an electronic apparatus such as a DVD (digital versatile disk) recorder.

2. Description of the Related Art

General-purpose remote controllers (so-called programmable remote controllers) each of which can be used as a remote controller for a plurality of AV apparatuses, etc. have been used broadly in recent years. For example, cellular phones each having an infrared transmission/reception function have been recently used as remote controllers. Unlike single purpose remote controllers, the remote controllers of the above-mentioned type have buttons need to be programmed, so that it is necessary to allocate functions to the buttons of the remote controllers (e.g. see JP-A-2001-092583).

As the number of functions included in a recent AV apparatus (Audio/Visual apparatus) such as a DVD recorder has increased, the number of buttons in a dedicated remote controller for the AV apparatus has increased to a very large number. For this reason, there arises a problem that the number of buttons to be allocated is insufficient when a cellular phone or the like is used as a remote controller.

In the conventional programmable remote controller, an operation such as switching or mode switching is performed on the remote controller side to thereby switch a button allocation state in accordance with necessity. However, the user per se needs to make the switching operation. As a result, the operation is complicated to bring poor convenience compared with the case where a dedicated remote controller is used.

In addition, there may be considered a method for automatically changing the state of the remote controller to a button allocation state required subsequently when a certain button is pushed down. In the case of this method, there are problems that (1) this method can hardly satisfy the case where there are a plurality of operating methods for switching the state, and that (2) this method cannot satisfy the case where a plurality of remote controllers including a dedicated remote controller are used together.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a system configuration view of a remote control system according to an embodiment;

FIG. 2 is a schematic configuration diagram of a cellular phone in the embodiment;

FIG. 3 is a view showing arrangement of buttons in the cellular phone in the embodiment;

FIG. 4 is a view showing a remote control code allocation table held in the cellular phone in the embodiment;

FIG. 5 is a view showing a menu screen of a video recorder apparatus displayed on a television monitor in the embodiment;

FIG. 6 is a chart showing a communication sequence in the remote control system according to the embodiment;

FIG. 7 is a view showing an operation guide displayed on the cellular phone in the embodiment; and

Fig. is a chart showing a communication sequence at the time of button allocation notification in the remote control system according to the embodiment.

### DETAILED DESCRIPTION

An embodiment will be described below with reference to the accompanying drawings.

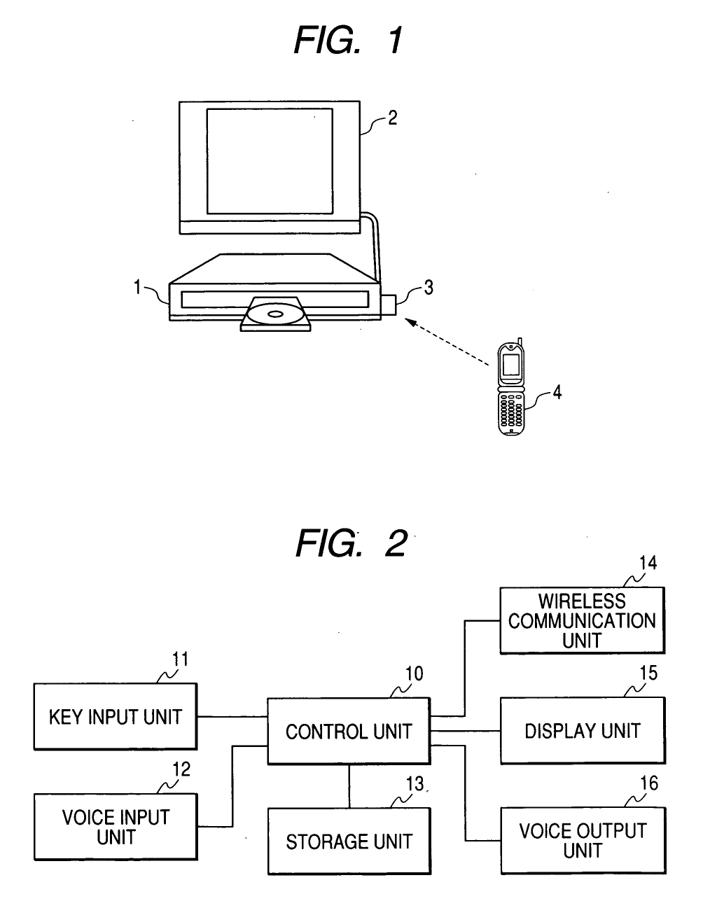

FIG. 1 is a system configuration view of a remote control system according to the embodiment. In FIG. 1, the reference numeral 1 designates a video recorder apparatus; 2, a television monitor; 3, a Bluetooth adaptor; and 4, a cellular phone.

The video recorder apparatus 1 is an AV apparatus provided with functions of (1) recording a television broadcast in a storage such as a hard disk drive, (2) displaying a list of recorded titles, and (3) playing back a title selected from the displayed list by a user.

The television monitor 2 is an output device for outputting video and audio of the video recorder apparatus 1. The Bluetooth adaptor 3 is a communication module attachably and detachably stored in the video recorder apparatus 1 and provided for mediating data exchange between the video recorder apparatus 1 and another apparatus by Bluetooth communication. In the embodiment, the cellular phone 4 is assumed to have a built-in Bluetooth communication function as well as a phone call function with another phone.

In the remote control system according to the embodiment, the cellular phone 4 is used as a remote controller for the video recorder apparatus 1. Communication between the cellular phone 4 and the video recorder apparatus 1 is made by Bluetooth. Since installation of Bluetooth in cellular phones has advanced recently to enable bidirectional communication, Bluetooth is most suitable as a communication unit to be used in this case. It is however unnecessary to limit the communication unit to Bluetooth particularly. For example, a wireless LAN or a transmittable/receivable infrared device may be used.

FIG. 2 is a schematic configuration diagram of the cellular phone 4. As shown in FIG. 2, the cellular phone 4 has a control unit 10, a key input unit 11, a voice input unit 12, a storage unit 13, a wireless communication unit 14, a display unit 15, and a voice output unit 16.

The control unit 10 handles control of the entire cellular phone 4. The key input unit 11 allows a user to input a key operation. The voice input unit 12 includes a microphone for inputting user's voice. The storage unit 13 includes a memory device for storing various kinds of data to be used by the control unit 10. The wireless communication unit 14 is a communication module for executing wireless communication for phone call and data exchange. The display unit 15 is a display device such as an LCD for displaying various kinds of information. The voice output unit 16 includes a speaker for outputting sounds and voice of an intended party.

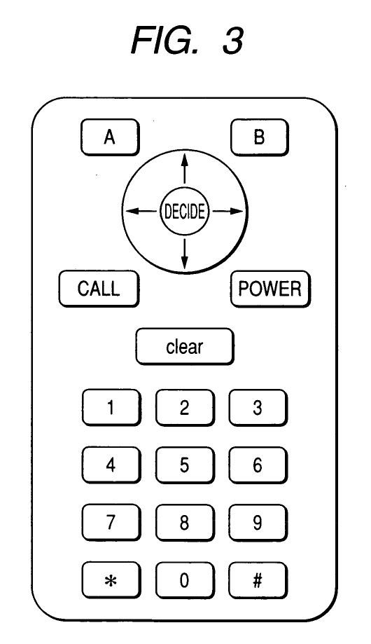

FIG. 3 shows arrangement of buttons in the cellular phone 4. Here, assume that all buttons except buttons “call” and “power” as shown in FIG. 3 are used as remote controller buttons.

Next, an example of use of the cellular phone 4 for remotely controlling the video recorder apparatus 1 in the remote control system according to the embodiment will be described.

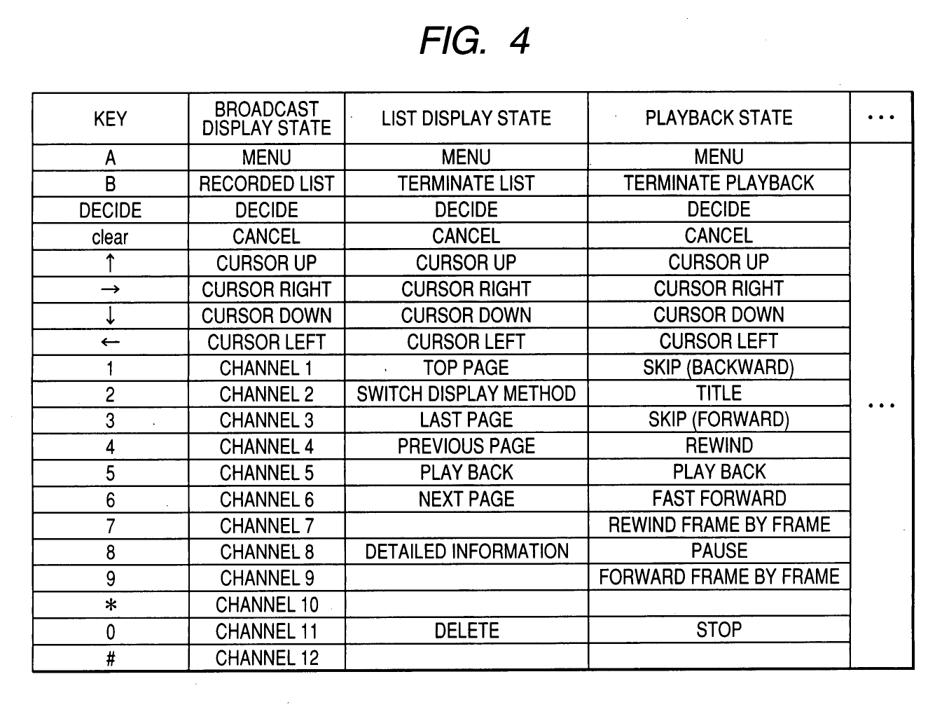

Assuming now that the video recorder apparatus 1 is in a state that a television broadcast is displayed on the television monitor 3. On this occasion, the cellular phone 4 is in a button allocation state indicated in a field “broadcast display state” in FIG. 4. When, for example, “5” is pushed down on the cellular phone 4, a remote control code of “channel 5” is sent to the video recorder apparatus 1 so that the broadcast of the channel 5 is displayed.

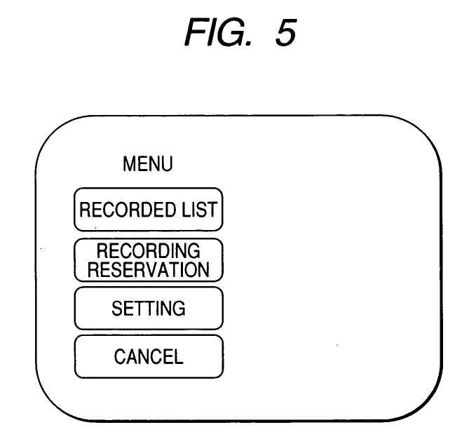

Consider now that the video recorder apparatus 1 is switched from this state to a recorded list display state. This switching operation can be achieved by pushing down “B” of the cellular phone 4 or by pushing down “A” of the cellular phone 4 to display a screen as shown in FIG. 5 on the television monitor 3, selecting “recorded list” from menu items by use of buttons “↓ (downward arrow)” and “↑ (upward arrow)”, and pushing down “enter”. In this manner, preparation of two methods for reaching a certain state, that is, preparation of a method using one remote controller button and a method of displaying a menu on a screen and selecting one item from the menu, is often made in the video recorder apparatus having complicated functions in order to attain improvement in user's convenience. Alternatively, this switching operation can be also achieved by use of another remote controller (e.g. a dedicated remote controller as an attachment to the video recorder apparatus 1) than the cellular phone 4.

When the video recorder apparatus 1 is switched to the recorded list display state by any one of the aforementioned operating methods, the cellular phone 4 is automatically switched to the button allocation state indicated in the field “list display state” in FIG. 4. When “5” is pressed down on this occasion in the same manner as described above, a remote control code of “playback” is sent to the video recorder apparatus 1 this time so that a playback of the selected recorded title is started.

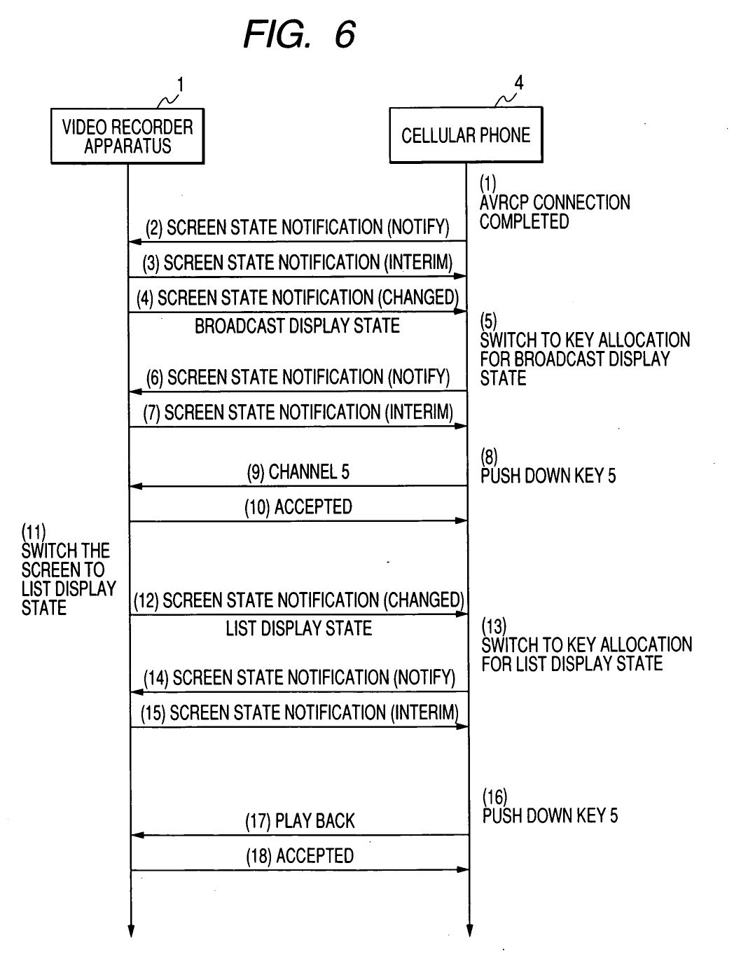

Next, a flow of communication between the cellular phone 4 and the video recorder apparatus 1 in the remote control system according to the embodiment will be described with reference to FIG. 6. Here, AVRCP (A/V Remote Control Profile) which is one of Bluetooth profiles and which is provided for controlling an AV apparatus is used as a communication method. This profile provides a communication protocol for remotely controlling an AV apparatus. When communication is made based on this profile, compatibility between apparatuses using the same AVRCP can be kept to some degree.

When AVRCP connection is completed (1), a screen state notification (notify) command (defined as a vendor dependent command in AVRCP) is sent from the cellular phone 4 to the video recorder apparatus 1 (2). This is a command for requesting the video recorder apparatus 1 to send a notice of switching of the screen state when the screen state of the video recorder apparatus 1 is switched.

Upon reception of this command, the video recorder apparatus 1 first sends a screen state notification (interim) (3). This indicates that the “notify” command has been accepted. Successively, the video recorder apparatus 1 sends a screen state notification (changed) accompanied by a parameter indicating the “broadcast display state” (4).

Upon reception of this notification (changed), the cellular phone 4 recognizes that the current state of the video recorder apparatus 1 is the broadcast display state, and sets button allocation for the broadcast display state (5). The cellular phone 4 sends a screen state notification (notify) command (6) again. Upon reception of this command, the video recorder apparatus 1 sends a screen state notification (interim) (7). In this manner, the cellular phone 4 always performs an operation of sending a screen state notification (notify) command again whenever the video recorder apparatus 1 sends a screen state notification (changed) back to the cellular phone 4 in response to a screen state notification (notify) command.

When the button “5” is pushed down on the cellular phone 4 in this state (8), the cellular phone 4 sends a command (defined as a “pass through” command in ACRCP) indicating “channel 5”. Upon reception of this command, the video recorder apparatus 1 switches its state to a state of display of the channel 5 broadcast and sends a response (accepted) to the “pass through” command (10).

Assuming now that the state of the video recorder apparatus 1 has been switched to a recorded list display state in accordance with the aforementioned operation (11). On this occasion, the video recorder apparatus 1 sends a screen state notification (changed) accompanied by a parameter indicating “list display state” (12). Upon reception of this notification (changed), the cellular phone 4 recognizes that the state of the video recorder apparatus 1 has been switched to the recorded list display state, and the cellular phone 4 switches its state to button allocation for the list display state (13). The transmission of the screen state notification (notify) command (14) and the transmission of the screen state notification (interim) (15) are repeated here.

When the button “5” is pushed down on the cellular phone 4 in the same manner as described above in this state (16), a command (defined as a “pass through” command in AVRCP) indicating “playback” is transmitted this time (17). Upon reception of this command, the video recorder apparatus 1 starts a playback of the selected title and transmits a response (accepted) to the “pass through” command (18).

According to the aforementioned communication, a function of automatically switching the button allocation of the cellular phone 4 can be achieved as soon as the state of the video recorder apparatus 1 is switched.

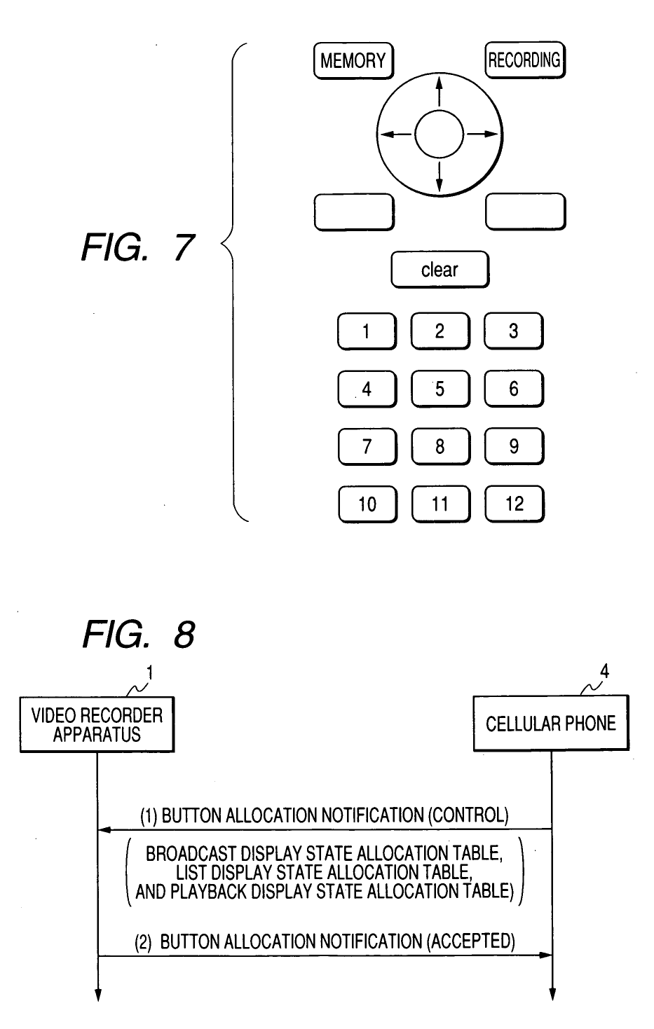

In the aforementioned embodiment, the current button allocation state of the cellular phone 4 may be displayed on the display unit 15 of the cellular phone 4 in such a shape shown in FIG. 7 or may be displayed in a lower part of a screen outputted by the video recorder apparatus 1.

Button allocation in the cellular phone 4 may be provided so as to be able to be set uniquely by the user. This function is often provided in a large number of cellular phones. In this case, the cellular phone 4 makes communication with the video recorder apparatus 1 as shown in FIG. 8 to give a notice of the setting contents immediately after the completion of connection of the cellular phone 4 to the video recorder apparatus 1. A flow of the communication on this occasion is as follows.

The cellular phone 4 transmits a button allocation notification (control) command (defined as a vendor dependent command in AVRCP) accompanied by a parameter indicating a list of button allocations for respective states (1). Upon reception of this command, the video recorder apparatus 1 transmits a button allocation notification (accepted) to the cellular phone 4 (2).

Thus, when the current button allocation state of the cellular phone 4 is displayed on the video recorder apparatus 1, the user's unique setting can be reflected.

As described above, in the remote control system according to the embodiment, the button allocation of the cellular phone 4 can be switched automatically as soon as the state of the video recorder apparatus 1 is switched. Thus, labor and time can be saved and convenience can be improved compared with the background-art case where the user per se has to perform a switching operation.

Moreover, since the current button allocation state is displayed on the screen of the video recorder apparatus 1 or on the liquid crystal panel of the cellular phone 4, the user can operate the buttons easily.

In addition, when the button allocation of the cellular phone 4 can be set uniquely by the user, the actual button allocation state can be reflected on the display of the video recorder apparatus 1 because the video recorder apparatus 1 is notified of the setting contents.

Incidentally, the invention is not limited to the embodiment and can be embodied by modification of the constituent members in a practical stage of the invention without departing from the gist of the invention. In addition, constituent members disclosed in the embodiment can be used in suitable combination to form various inventions. For example, several constituent members may be removed from all the constituent members disclosed in the embodiment. Moreover, constituent members in different embodiments may be used in suitable combination.

As described above, there is provided an electronic apparatus improved in handling property in such a manner that allocation of functions of operation buttons is switched automatically in accordance with change in the state of an apparatus to be controlled.

It is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

While certain embodiment of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
an operation button that inputs remote operation for remotely controlling another apparatus; and
a switching unit that switches a function of the remote operation allocated to the operation button in accordance with a change of a state of the another apparatus.

2. An electronic apparatus according to claim 1, further comprising a display unit that displays the function of the remote operation allocated to the operation button.

3. An electronic apparatus comprising:
a wireless communication unit that performs wireless communication with another apparatus;
an operation button;
a state acquisition unit that acquires a state of the another apparatus through the wireless communication unit;
a management unit that manages correspondence between the operation button and an instruction allocated to the operation button for remotely controlling the another apparatus, in accordance with the state acquirable by the state acquisition unit; and
a transmission unit that transmits a command to the another apparatus through the wireless communication unit when the operation button is operated, the command indicating the instruction allocated to the operation button for the state acquired by the state acquisition unit.

4. An electronic apparatus according to claim 3, wherein the acquisition unit acquires the state of the another apparatus by transmitting through the wireless communication unit a command for requesting the another apparatus to send a notice of the change of the state when the state of the another apparatus is changed.

5. An electronic apparatus according to claim 3, further comprising:
a display unit; and
a display control unit that controls the display unit to display a list of current correspondence between the operation button and the instruction allocated to the operation button.

6. An electronic apparatus according to claim 5, wherein the display control unit controls the display unit so that the display of the list matches with the arrangement of the operation button.

7. An electronic apparatus according to claim 3, further comprising a display control unit that transmits a command to the another apparatus through the wireless communication unit, the command for displaying a list of current correspondence between the operation button and the instruction allocated to the operation button.

8. An electronic apparatus according to claim 7, wherein the display control unit transmits through the wireless communication unit a list data indicating the correspondence between the operation button and the instruction allocated to the operation button.
